(19) United States
(12) Patent Application Publication
(10) Pub. No.: US 2026/0216694 A1
(43) Pub. Date: Jul. 30, 2026

(54) POROUS SCAFFOLD FOR SOLID DESICCANT

(71) Applicant: Carrier Corporation, Palm Beach Gardens, FL (US)

(72) Inventor: Aaron Kueck, Ithaca, NY (US)

(21) Appl. No.: 19/448,466

(22) Filed: Jan. 14, 2026

Related U.S. Application Data
(60) Provisional application No. 63/749,935, filed on Jan. 27, 2025.

(51) Int. Cl. B01J 20/22; B01D 53/26; B01J 20/10; B01J 20/16; B01J 20/30; F28F 3/02

(52) U.S. Cl. CPC B01J 20/226; B01D 53/261; B01J 20/103; B01J 20/165; B01J 20/3057; B01J 20/3078; F28F 3/02; B01D 2253/108; B01D 2253/204; F28F 2245/00; F28F 2255/00

(57) ABSTRACT

A method of producing a porous scaffold for solid desiccant is provided. The method includes dissolving a scaffold precursor and dispersing desiccant particles in a solvent to create a mixture, placing a substrate in the solvent with the mixture, encouraging the scaffold precursor and the desiccant particles to collect on surfaces of the substrate and to grow crystals therefrom, removing the solvent while leaving the scaffold precursor as a porous scaffold on which the desiccant particles are supported and at least partially exposed and consolidating the porous scaffold with the desiccant particles supported thereon and at least partially exposed.

### CROSS REFERENCE TO A RELATED APPLICATION

The application claims the benefit of U.S. Provisional Application 63/749,935 filed Jan. 27, 2025, the contents of which are hereby incorporated in their entirety

### BACKGROUND

The present disclosure relates to dehumidification systems and, more particularly, to a method of producing porous scaffolds for solid desiccants via freeze casting for dehumidification systems.

A desiccant is a substance that absorbs moisture from the environment, due to its high affinity for water vapor, thus helping to keep the surrounding area dry. Desiccants typically include hygroscopic materials that attract and hold water vapor from the air to induce or sustain a state of dryness (desiccation) in its vicinity. Industrially, desiccants are widely used for moisture control in packaging, pharmaceuticals, electronics, food preservation and dehumidification systems to maintain product integrity and prevent corrosion.

### BRIEF DESCRIPTION

According to an aspect of the disclosure, a method of producing a porous scaffold for solid desiccant is provided. The method includes dissolving a scaffold precursor and dispersing desiccant particles in a solvent to create a mixture, placing a substrate in the solvent with the mixture, encouraging the scaffold precursor and the desiccant particles to collect on surfaces of the substrate and to grow crystals therefrom, removing the solvent while leaving the scaffold precursor as a porous scaffold on which the desiccant particles are supported and at least partially exposed and consolidating the porous scaffold with the desiccant particles supported thereon and at least partially exposed.

In accordance with one or more additional and/or alternative embodiments, the desiccant particles includes at least one or more of silica, zeolites and metal-organic frameworks (MOFs) and the scaffold precursor includes at least one or more of a water soluble polymer and an alcohol-soluble polymer.

In accordance with one or more additional and/or alternative embodiments, the encouraging of the scaffold precursor and the desiccant particles to collect includes freezing.

In accordance with one or more additional and/or alternative embodiments, the freezing includes controlling respective temperatures of the solvent and the substrate in accordance with a predetermined desired crystal size.

In accordance with one or more additional and/or alternative embodiments, the encouraging of the scaffold precursor and the desiccant particles to collect includes seeding crystal growth.

In accordance with one or more additional and/or alternative embodiments, the removing of the solvent includes at least one of reducing pressure for sublimation and super-critical drying.

In accordance with one or more additional and/or alternative embodiments, the removing of the solvent further includes localized heating.

In accordance with one or more additional and/or alternative embodiments, the removing of the solvent includes desiccant activation.

In accordance with one or more additional and/or alternative embodiments, the consolidating of the porous scaffold with the desiccant particles supported thereon and at least partially exposed includes curing the porous scaffold.

According to an aspect of the disclosure, a method of producing a porous scaffold for solid desiccant on a heat exchanger is provided. The method includes dissolving a scaffold precursor and dispersing desiccant particles in a solvent to create a mixture, placing a surface of the heat exchanger in the solvent with the mixture, reducing respective temperatures of the surface of the heat exchanger and the solvent to encourage the scaffold precursor and the desiccant particles to collect on the surface of the heat exchanger and to grow crystals therefrom, removing the solvent while leaving the scaffold precursor as a porous scaffold supported on the surface of the heat exchanger and on which the desiccant particles are supported and at least partially exposed and consolidating the porous scaffold with the desiccant particles supported thereon and at least partially exposed.

In accordance with one or more additional and/or alternative embodiments, the desiccant particles includes at least one or more of silica, zeolites and metal-organic frameworks (MOFs) and the scaffold precursor includes at least one or more of a water soluble polymer and an alcohol-soluble polymer.

In accordance with one or more additional and/or alternative embodiments, the encouraging of the scaffold precursor and the desiccant particles to collect includes freezing.

In accordance with one or more additional and/or alternative embodiments, the freezing includes flowing coolant through the heat exchanger and controlling the respective temperatures of the solvent and the surface of the heat exchanger in accordance with a predetermined desired crystal size.

In accordance with one or more additional and/or alternative embodiments, the encouraging of the scaffold precursor and the desiccant particles to collect includes seeding crystal growth.

In accordance with one or more additional and/or alternative embodiments, the removing of the solvent includes at least one of reducing pressure for sublimation and super-critical drying.

In accordance with one or more additional and/or alternative embodiments, the removing of the solvent further includes localized heating.

In accordance with one or more additional and/or alternative embodiments, the removing of the solvent includes desiccant activation.

In accordance with one or more additional and/or alternative embodiments, the consolidating of the porous scaffold with the desiccant particles supported thereon and at least partially exposed includes curing the porous scaffold.

According to an aspect of the disclosure, a heat exchanger is provided for a dehumidification system. The heat exchanger includes tubes, fins disposed in thermal contact with the tubes, a porous scaffold supported on respective surfaces of at least one of the tubes and the fins and desiccant particles supported on and at least partially exposed from the porous scaffold.

In accordance with one or more additional and/or alternative embodiments, the desiccant particles include at least one or more of silica, zeolites and metal-organic frameworks (MOFs).

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts:

FIG. 1 is a flow diagram illustrating a method of producing a porous scaffold for solid desiccant in accordance with embodiments;

FIG. 2 is a side schematic view showing a first stage of the method of FIG. 1 in accordance with embodiments;

FIG. 3 is a side schematic view showing a second stage of the method of FIG. 1 in accordance with embodiments;

FIG. 4 is a side schematic view showing a third stage of the method of FIG. 1 in accordance with embodiments;

FIG. 5 is a side schematic view showing a fourth stage of the method of FIG. 1 in accordance with embodiments;

FIG. 6A is a side schematic view of a dehumidification system including a porous scaffold with desiccant particles on a heat exchanger in accordance with embodiments; and

FIG. 6B is an enlarged view of the portion of FIG. 6A encircled by dashed line 6B-6B showing the desiccant particles supported on and at least partially exposed from the porous scaffold in accordance with embodiments.

### DETAILED DESCRIPTION

Solid desiccant materials for independent dehumidification often require an underlying substrate, such as a material of a heat exchanger. One option for applying solid desiccant to the heat exchanger having the underlying substrate is to coat the fins of the heat exchanger with desiccant. This can be problematic, however, as the coating processes can introduce a thermal barrier between air and the fins and can potentially clog air passages of the heat exchanger if the coating is excessively thick in certain places (excessive local thickness).

Thus, as will be described below, a freeze casting process is provided for use in producing a porous scaffold between elements of any surface of interests, such as the fins of a heat exchanger. Desiccants with a metal-organic framework (MOF) or other soluble/suspended desiccants and an inert scaffold precursor, such as a polymer-based precursor, are dissolved or dispersed in water or another solvent. For the case of applying the porous scaffold to fins of a heat exchanger, the water or solvent is directionally solidified between the fins by running cold liquid through the heat exchanger. Ice crystal shape can be controlled during this process stage by solute loading, freeze rate, etc. Solute rejection during solidification forms a complex three-dimensional (3D) network of scaffolding and desiccant. The water or solvent is then removed by sublimation or another similar process, leaving behind the scaffolding with the desiccant.

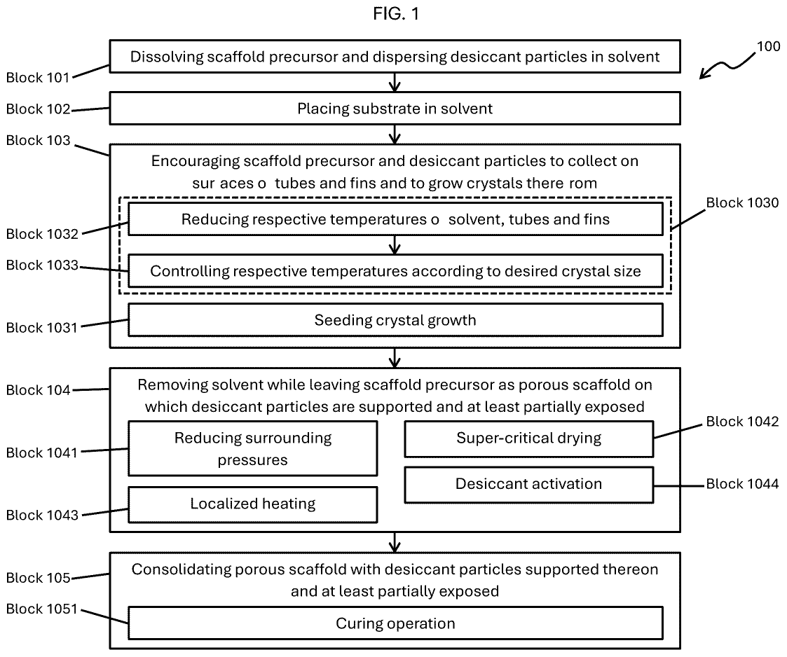

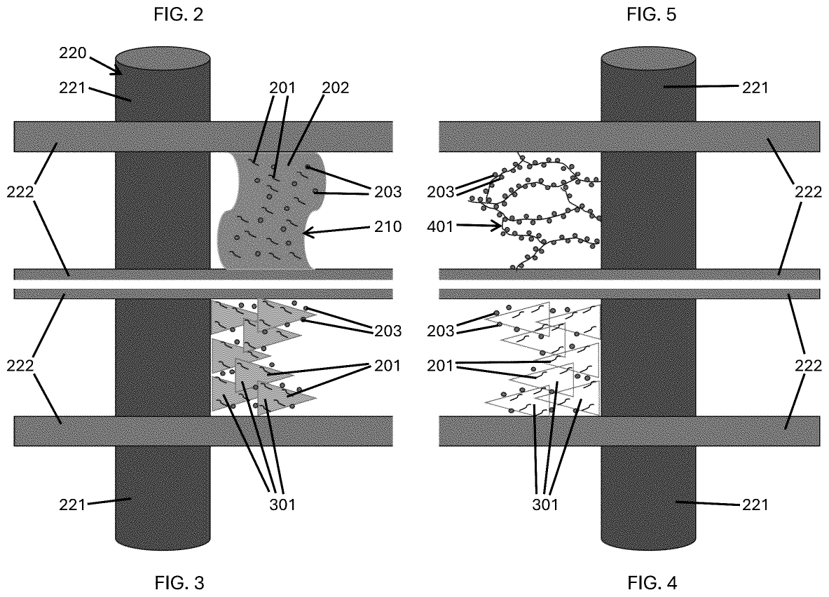

With reference to FIG. 1 and to FIGS. 2-5, a method 100 of producing a porous scaffold 501 (see FIG. 5) for solid desiccant is provided.

As shown in FIGS. 1 and 2, the method 100 includes dissolving a scaffold precursor 201 in a solvent 202 and dispersing desiccant particles 203 in the solvent 202 to create a mixture 210 (block 101) and placing a substrate 220 in the solvent 202 with the mixture 210 (block 102). In accordance with embodiments, the desiccant particles 203 can include at least one or more of silica, zeolites and metal-organic frameworks (MOFs), the scaffold precursor 201 can include at least one or more of a medium-to-high molecular weight water soluble polymer and a medium-to-high molecular weight alcohol-soluble polymer such as polyvinyl alcohol (PVA), polyacrylamide (PAM or PAAM), polyvinylpyrrolidone (PVP), etc., and the solvent 202 can include at least one or more of water, alcohol, a mix of water and alcohol, combinations thereof and combinations thereof with one or more surfactants. The substrate 220 can include or be provided as a portion of a heat exchanger, for example, and can include metallic surfaces of tubes 221 (hereinafter referred to as “tubes 221”) and metallic surfaces of fins 222 (hereinafter referred to as “fins 222”) in thermal contact with the tubes 221.

As used herein, MOFs are highly effective desiccants due to their large surface area and tunable adsorption properties. They are well-suited for use in HVAC systems due to their high efficiency in moisture capture. MOFs have demonstrated robust performance in experimental studies, retaining their structural integrity and adsorption capacity over multiple cycles of hydration and dehydration, which is critical for sustainable applications. MOFs such as MOF Cr, MOF Al, and MOF Fe offer high porosity and customizable sorption properties, leading to superior water adsorption capacity compared to conventional materials. Among these, MOF Al (MIL 100 (Al) is renowned for its exceptionally high surface area, which facilitates effective moisture retention.

One of the most compelling advantages of using MOFs in freeze casting is their significantly enhanced water adsorption capacity compared to traditional solid desiccants like silica gel. MOFs exhibit a unique crystalline structure that allows for a larger surface area and tunable pore sizes, facilitating superior water absorption. The stability of the desiccant material under varying humidity conditions is vital for long-term applications.

MOFs with a maximum hygroscopic capacity of >1 g/g MIL-101 (Cr) exemplify stable MOFs with a water adsorption capacity exceeding 100 wt %. MOFs with a maximum hygroscopic capacity of <0.5 g/g MIL-53-FA can be regenerated using the waste heat of the condenser and it has an adsorption capacity of about 0.45 g/g. Water: Commonly used due to its effective freezing properties and compatibility with the MOF. Other suitable solvents include dimethyl sulfoxide (DMSO) or methanol; however, water is preferred for its availability and ease of handling. Glutaraldehyde or PVA (Polyvinyl Alcohol) can be used as binders or scaffold to improve green body strength during the freeze casting process. Binders serve to enhance the mechanical stability of the material once solidified but should not interfere with the adsorption capabilities of the MOF. Hydroxyethyl cellulose (HEC) plays a significant role in the development and coating of solid desiccants, particularly in applications involving aluminum heat exchangers. As a water-soluble polymer derived from cellulose, HEC exhibits multiple attributes that make it an ideal binder in this context. One of the key advantages of HEC is its ability to form stable and uniform dispersions with solid desiccants, promoting even coating on substrates such as aluminum. This uniform distribution is crucial for achieving optimal moisture adsorption properties, as it ensures that the desiccant layer is consistently applied, minimizing the risk of weak spots that could obstruct performance. Furthermore, HEC enhances the mechanical strength and durability of the coating, preventing delamination or cracking under varying operational conditions.

| KPI | | | | |
|---|---|---|---|---|
| (Material) | METRIC | (MOF Al) | (MOF Cr) | LICL-SG |
| Adsorption | g/g | 1 g/g | 1.43 g/g | 0.35 g/g |
| capacity | | | | |
| Degradation | g | low | <4% per 1000 | — |
| | | | Cycle | |
| Thermal | K | Thermal | Thermal | — |
| Stability | | stability: >573° K; | stability: >573° K | |
| Thermal | W/(mk) | 0.07 W/(mK) | 0.05 W/(mK) | (5.8 |
| Conductivity | | | | m − 1K − 1 |
| PH/Water | — | Stable in air | Stable in air, | yes |
| Stability | | for several weeks | aqueous, acid and | |
| | | | basic solution | |
| | | | (PH 1-12) | |
| Coating Impact | — | Yes | Yes | yes |
| Regeneration | C. | <120 C. | <90 C. | <90 |
| temperature | | | | |
| Toxicity/EHS | Lethal | nontoxic | Low toxic | Nontoxic |
| | Dose 50% | | | |
| Physical Properties | Pore | 1.5 nm, 200 nm; | 0.9 cm³/g/ | |
| | Volume/size | 500 nm; 1 μm; | Window size: | |
| | | 5 μm (Can | 0.55-0.88 nm; | |
| | | be customized | pore size: | |
| | | | 2.5-2.9 nm | |
| Surface area | Specific | 900 m²/g | 1900 m²/g | 120-140 |
| | Surface | (by BET) | (by BET) | m²/g |

For structurally stable and directly usable MOFs selected, the direct synthesis strategy can be considered. MOFs that require optimization before use may be better suited for dip-coating or spray-coating techniques. The direct synthesis strategy results in MCHEs characterized by a tighter and more robust integration of MOFs and heat exchangers eliminating the need for binders, which may be more favorable for heat transfer and water molecule transport. Regarding LiCl-Silica gel composites, LiCl is a highly hygroscopic material and combining it with silica gel enhances its ability to adsorb moisture. LiCl is a highly hygroscopic material and combining it with silica gel enhances its ability to adsorb moisture. Water is typically used as the solvent for LiCl, while silica-based scaffolds are ideal for freeze casting due to their stability and high surface area. In contrast, LiCl-Silica Gel Composites, Zeolite, and Alumin are more traditional sorbents. Zeolite provides good performance in moisture control; however, it requires relatively high regeneration temperatures and may be prone to degradation under certain atmospheric conditions

The mixture 210 can be provided as a slurry. The dissolving of the scaffold precursor 201 in the solvent 202 and the dispersing of the desiccant particles 203 in the solvent 202 to create the mixture 210 (or slurry) of block 101 can involve dispersing particles into the selected solvent (e.g., water or another similar solvent) at an appropriate solid loading level, often ranging between 20-40% by weight. Thorough mixing achieves a uniform distribution of particles within the solvent. Organic binders may be added to enhance the stability and mechanical integrity of the mixture 210 (or slurry) during freezing. The temperature of the mixture 210 (or slurry) may fall in the range where the solvent is liquid, room temperature in the case of water, but different temperatures (60° C. and 8° C.) may be necessary for respectively camphene-based and tert-butyl alcohol. slurries. Moderate solid loading may be used (10-40 vol. %), depending on the desired amount of total porosity. The stability of the suspension can be carefully controlled to avoid segregation phenomena, yielding gradients of density and porosity in the final materials. The binder provides green strength after sublimation (to be discussed below). Though the solvent is playing the role of the structuring agent, binder and pore forming agent, it is nevertheless removable during the sublimation.

The following description will generally refer to the case in which the substrate 220 is provided as the portion of the heat exchanger where the heat exchanger includes the tubes 221 for carrying a first fluid and the fins 222 for facilitating heat exchange between the first fluid and a second fluid flowing over and around the fins 222. This is being done for purposes of clarity and brevity and should not be interpreted as limiting the disclosure or the following claims in any way.

As shown in FIGS. 1 and 3, the method 100 includes encouraging the scaffold precursor 201 and the desiccant particles 203 to collect on surfaces of the tubes 221 and the fins 222 and to grow crystals 301 therefrom (block 103). In accordance with embodiments, the encouraging of the scaffold precursor 201 and the desiccant particles 203 to collect can include a freezing process (block 1030) and seeding crystal 301 growth (block 1031). The freezing process of block 1030 can include reducing respective temperatures of the solvent 202, the tubes 221 and the fins 221, such as by flowing coolant through the tubes 221 (block 1032) as well as controlling the respective temperatures of the solvent 202 and the surface of the tubes 221 and the fins 222 in accordance with a predetermined desired crystal 301 size (block 1033).

The freezing process can further include placement of the mixture 210 (or the slurry), tubes 221 and the fins 222 in a mold to provide a desired shape of a final product.

Crystal 301 growth during the freezing process of block 1030 can be controlled. By controlling the overall bath temperature of the solvent 202 and by controlling the respective temperatures of the solid surfaces of the tubes 221 and the fins 222, such as by flowing the coolant through the tubes 221, it is possible to control how fast the crystals 301 grow and the sizes of the crystals 301 that form. Faster freezing may result in small crystals 301 whereas slow freezing may result in a few large crystals 301. It may also be possible to obtain different crystal 301 shapes, such as dendrites, by changing or adjusting relative solubilities of the components in the solid and liquid and by changing or adjusting relative solidification rates. In some cases, by making the tubes 221 and the fins 222 the source of cold temperatures that cause freezing, it may be possible to directionally solidify the crystals 301 starting from the tubes 221 and the fins 222.

As shown in FIGS. 1 and 4 and in FIGS. 1 and 5, the method 100 includes removing the solvent 202 while leaving the scaffold precursor 201 as a porous scaffold 401 on which the desiccant particles 203 are supported and at least partially exposed (block 104) and consolidating the porous scaffold 401 with the desiccant particles supported thereon and at least partially exposed (block 105). The removing of the solvent of block 104 can include at least one or more of reducing surrounding pressures (block 1041) and super-critical drying (block 1042) and, in some cases, localized heating (block 1043) as well as desiccant activation (block 1044).

In accordance with embodiments, materials of the scaffold precursor 201 and the desiccant particles 203 can be chosen such that as the scaffold precursor 201 is reformed as the porous scaffold 401, the desiccant particles 203 are securely seated on the porous scaffold 401 by at least one or more of chemical bonds or affinities, electrostatic bonds or affinities and mechanical interlocks (i.e., where the porous scaffold 401 includes polymer string that wraps around and effectively grips onto the desiccant particles 203).

The removal of the solvent 202 of block 104 can involve a pressure swing in addition to a temperature change since temperature changes alone could melt the porous scaffold 401. The pressure drop can serve to encourage sublimation (i.e., direct solid-to-gas phase change). In any case, the removal of the solvent 202 of block 104 can be executed relatively slowly such that the porous scaffold 401 remains intact. A subsequent heating operation, such as the localized heating of block 1043, can serve to remove the remaining solvent and assist in curing the porous scaffold in a curing operating (block 1051) of the consolidating of block 105.

In the case of sublimation being used, once complete solidification is achieved, low temperature and reduced pressure conditions can be maintained according to physical properties of the solvent. Porosity is created where solvent crystals were, so that a green porous structure is obtained; the porosity can be a direct replica of the solidified solvent structure. When using water, a conventional freeze-dryer can be used. In the case of camphene, a vapor pressure of 1.3 kPa (just below the melting temperature) can be high enough to allow sublimation at room temperature, so that no specific equipment is required

As to the consolidating of block 105, the scaffold precursor 201 can be selected as a type of polymer that becomes cross-linked following the removal of the solvent 202 of block 104 so that the porous scaffold 401 remains intact with stability and does not collapse. In a general sense, the porous scaffold 401 provides support for seating the desiccant particles 203 thereon whereby an effective surface area of the desiccant particles 203 on the tubes 221 and the fins 222 is relatively increased.

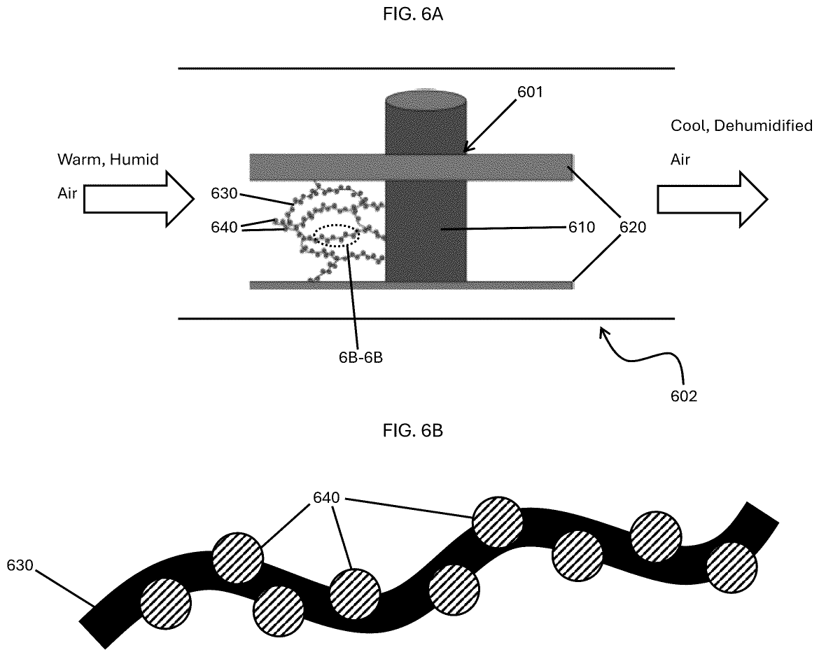

With continued reference to FIG. 5 and with additional reference to FIGS. 6A and 6B, a heat exchanger 601 is provided for a dehumidification system 602. The heat exchanger 601 includes tubes 610 and fins 620 disposed in thermal contact with the tubes 610 generally as described above as well as a porous scaffold 630 that is supported on respective surfaces of at least one of the tubes 610 and the fins 620 and desiccant particles 640 supported on and at least partially exposed from the porous scaffold 630. Again, as described above, the desiccant particles 640 can include at least one or more of silica, zeolites and MOFs. As shown in FIG. 6A, the heat exchanger 601 can be placed in an airflow of warm and humid air whereby, as the airflow passes over the heat exchanger 601, the airflow is cooled and dehumidified. The cooling of the airflow can be achieved by flowing coolant through the tubes 610 such that heat is removed from the airflow by thermal exchange via the tubes 610 and the fins 620. The dehumidification of the airflow can be achieved by the interaction of the airflow with the desiccant particles 640 being supported on and at least partially exposed from the porous scaffold 630 as shown in FIG. 6B.

Technical effects and benefits of the present disclosure are the provision of a porous 3D network with attached desiccant in, for example, the air spaces between fins of a heat exchanger. Desiccant quantity and coverage can be controlled by the loading level and freezing parameters used in the process.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

While the preferred embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A method of producing a porous scaffold for solid desiccant, the method comprising:
dissolving a scaffold precursor and dispersing desiccant particles in a solvent to create a mixture;
placing a substrate in the solvent with the mixture;
encouraging the scaffold precursor and the desiccant particles to collect on surfaces of the substrate and to grow crystals therefrom;
removing the solvent while leaving the scaffold precursor as a porous scaffold on which the desiccant particles are supported and at least partially exposed; and
consolidating the porous scaffold with the desiccant particles supported thereon and at least partially exposed.

2. The method according to claim 1, wherein:
the desiccant particles comprise at least one or more of silica, zeolites and metal-organic frameworks (MOFs), and
the scaffold precursor comprises at least one or more of a water soluble polymer and an alcohol-soluble polymer.

3. The method according to claim 1, wherein the encouraging of the scaffold precursor and the desiccant particles to collect comprises freezing.

4. The method according to claim 3, wherein the freezing comprises controlling respective temperatures of the solvent and the substrate in accordance with a predetermined desired crystal size.

5. The method according to claim 1, wherein the encouraging of the scaffold precursor and the desiccant particles to collect comprises seeding crystal growth.

6. The method according to claim 1, wherein the removing of the solvent comprises at least one of reducing pressure for sublimation and super-critical drying.

7. The method according to claim 6, wherein the removing of the solvent further comprises localized heating.

8. The method according to claim 1, wherein the removing of the solvent comprises desiccant activation.

9. The method according to claim 1, wherein the consolidating of the porous scaffold with the desiccant particles supported thereon and at least partially exposed comprises curing the porous scaffold.

10. A method of producing a porous scaffold for solid desiccant on a heat exchanger, the method comprising:
dissolving a scaffold precursor and dispersing desiccant particles in a solvent to create a mixture;
placing a surface of the heat exchanger in the solvent with the mixture;
reducing respective temperatures of the surface of the heat exchanger and the solvent to encourage the scaffold precursor and the desiccant particles to collect on the surface of the heat exchanger and to grow crystals therefrom;
removing the solvent while leaving the scaffold precursor as a porous scaffold supported on the surface of the heat exchanger and on which the desiccant particles are supported and at least partially exposed; and
consolidating the porous scaffold with the desiccant particles supported thereon and at least partially exposed.

11. The method according to claim 10, wherein:
the desiccant particles comprise at least one or more of silica, zeolites and metal-organic frameworks (MOFs), and
the scaffold precursor comprises at least one or more of a water soluble polymer and an alcohol-soluble polymer.

12. The method according to claim 10, wherein the encouraging of the scaffold precursor and the desiccant particles to collect comprises freezing.

13. The method according to claim 12, wherein the freezing comprises:
flowing coolant through the heat exchanger; and
controlling the respective temperatures of the solvent and the surface of the heat exchanger in accordance with a predetermined desired crystal size.

14. The method according to claim 10, wherein the encouraging of the scaffold precursor and the desiccant particles to collect comprises seeding crystal growth.

15. The method according to claim 10, wherein the removing of the solvent comprises at least one of reducing pressure for sublimation and super-critical drying.

16. The method according to claim 15, wherein the removing of the solvent further comprises localized heating.

17. The method according to claim 10, wherein the removing of the solvent comprises desiccant activation.

18. The method according to claim 10, wherein the consolidating of the porous scaffold with the desiccant particles supported thereon and at least partially exposed comprises curing the porous scaffold.

19. A heat exchanger for a dehumidification system, the heat exchanger comprising:
tubes;
fins disposed in thermal contact with the tubes;
a porous scaffold supported on respective surfaces of at least one of the tubes and the fins; and
desiccant particles supported on and at least partially exposed from the porous scaffold.

20. The heat exchanger according to claim 10, wherein the desiccant particles comprise at least one or more of silica, zeolites and metal-organic frameworks (MOFs).
